(19) United States
(12) Patent Application Publication
(10) Pub. No.: US 2003/0121546 A1
(43) Pub. Date: Jul. 3, 2003

(54) Exhaust air guiding cap assembly for a pneumatic tool

(76) Inventor: Chen Ming Hsien, Taichung City (TW)

Correspondence Address: CHARLES E. BAXLEY, ESQUIRE, Hart, Baxley, Daniels & Holton, 59 John St, 5 Fl, New York, NY, 10038, US

(21) Appl. No.: 10/224,410

(22) Filed: Aug. 21, 2002

(30) Foreign Application Priority Data
Dec. 31, 2001 (CN) 090224830

(51) Int. Cl. F16K 1/00

(52) U.S. Cl. 137/219

(57) ABSTRACT

An exhaust air guiding assembly for a pneumatic tool includes a base with a recess defined therein and a plurality of notches are defined in an inner periphery of the recess. An opening is defined through the cap for releasing the exhaust air of the tool, and a cap is rotatably engaged with the recess. A biasing piece is connected to the cap and engaged with one of the notches. The user may push the biasing piece and rotate the cap till the biasing piece is engaged with another notch so as to change the position of the opening of the cap.

### FIELD OF THE INVENTION

The present invention relates to an exhaust air guiding cap assembly for a pneumatic tool wherein the cap has a biasing piece on a periphery thereof which is movably engaged with one of notches defined in an inner periphery of the base for receiving the cap.

### BACKGROUND OF THE INVENTION

A conventional pneumatic tool includes a piston movably received in the tool and ejects a nail or staple by pneumatic power when the piston moves in the cylinder. The nails or the staples can be ejected one by one by pulling the trigger continuously. The exhaust air releases from an opening in an exhaust air guiding cap when the piston moves reciprocatingly in the cylinder. However, the position of the opening of the exhaust air guiding cap is not changed because the exhaust air guiding cap is fixed to the base by a screw so that the exhaust air could hit toward the user when the tool is used at a certain angle or orientation. This makes the user feel uncomfortable and cannot concentrate.

The present invention intends to provide an exhaust air guiding cap assembly wherein the cap has a biasing piece engaged with one of notches in an inner periphery of a base so that the cap can be rotated by pushing the biasing piece from one notch and re-engaging another notch to change the position of the opening of the cap.

### SUMMARY OF THE INVENTION

In accordance with one aspect of the present invention, there is provided an exhaust air guiding assembly for a pneumatic tool and the assembly comprises a base with a recess defined therein and a plurality of notches defined in an inner periphery of the recess. A cap with a biasing piece is rotatably engaged with the recess and the biasing piece is engaged with one of the positioning devices. An opening is defined through the cap so as to release the exhaust air and the position of the opening is changed by rotating the cap.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the exhaust air cap assembly of the present invention;

FIG. 2 is a top cross sectional view to show the exhaust air cap assembly of the present invention;

FIG. 3 is a top cross sectional view to show the biasing piece is pushed inward;

FIG. 4 is a top cross sectional view to show that the biasing piece is engaged with another notch;

FIG. 5 is a side cross sectional view to show the exhaust air cap assembly of the present invention; and

FIG. 6 shows another embodiment of the exhaust air cap assembly of the present invention.

### DETAILED DESCRIPTION OF THE PREFERRED EMBODIMENT

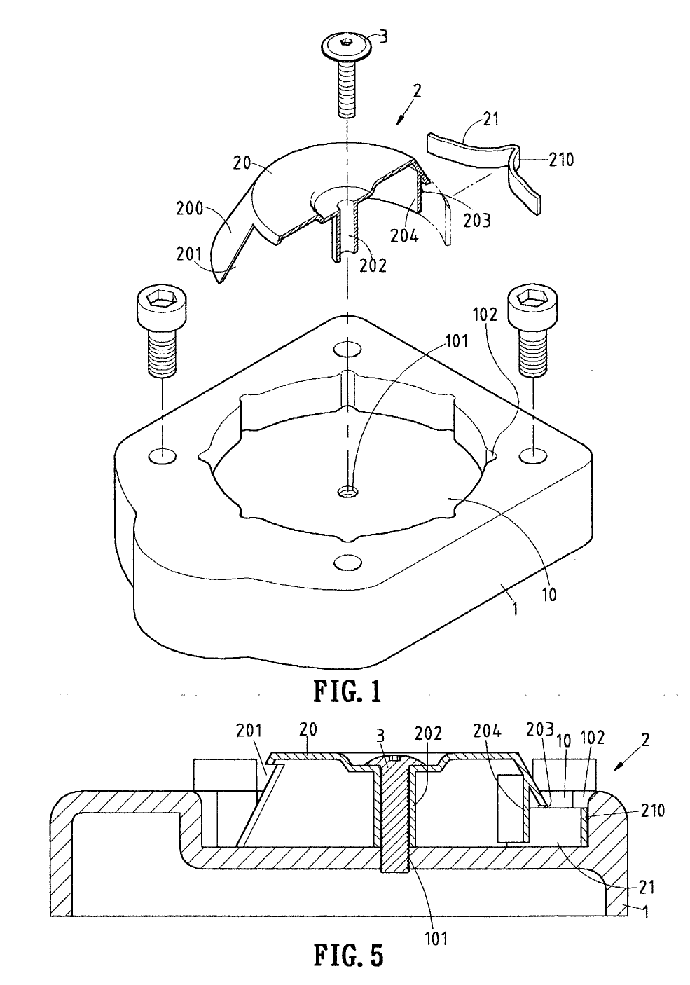

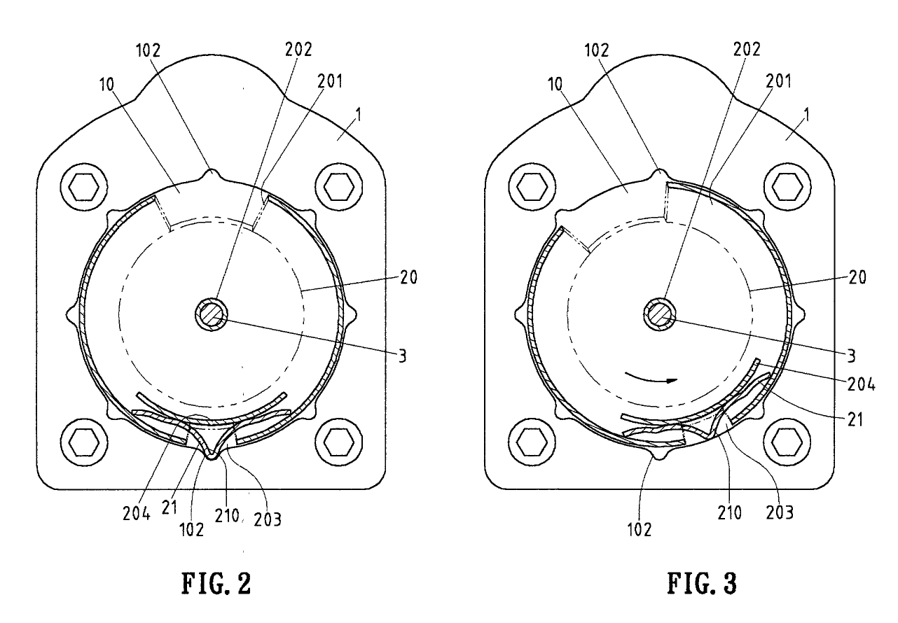

Referring to FIGS. 1, 2 and 5, the exhaust air cap assembly of the present invention comprises a base 1 connected to the pneumatic tool (not shown) and a recess 10 is defined in the base 1. A plurality of positioning devices such as notches 102 are defined in an inner periphery of the recess 10.

A cap 2 is rotatably engaged with the recess 10 and includes a top 20 and a skirt 200 through which an opening 201 is defined so that the exhaust air during operating the pneumatic tool is released from the opening 201. A tube 202 extends from an underside of the top 20 of the cap 2 and a bolt 3 extends through the tube 202 and is engaged with a hole 101 defined in an inside of the recess 10. A backing plate 204 extends from a back surface of the skirt 200 and a cut-away 203 is defined in the skirt 200. The backing plate 204 is located in correspondence to the cut-away 203. A biasing piece 21 is received in the cut-away 203 and contacts the backing plate 204. The biasing piece 21 has a protrusion 210 which extends through the cut-away 203 and is engaged with one of the notches 102.

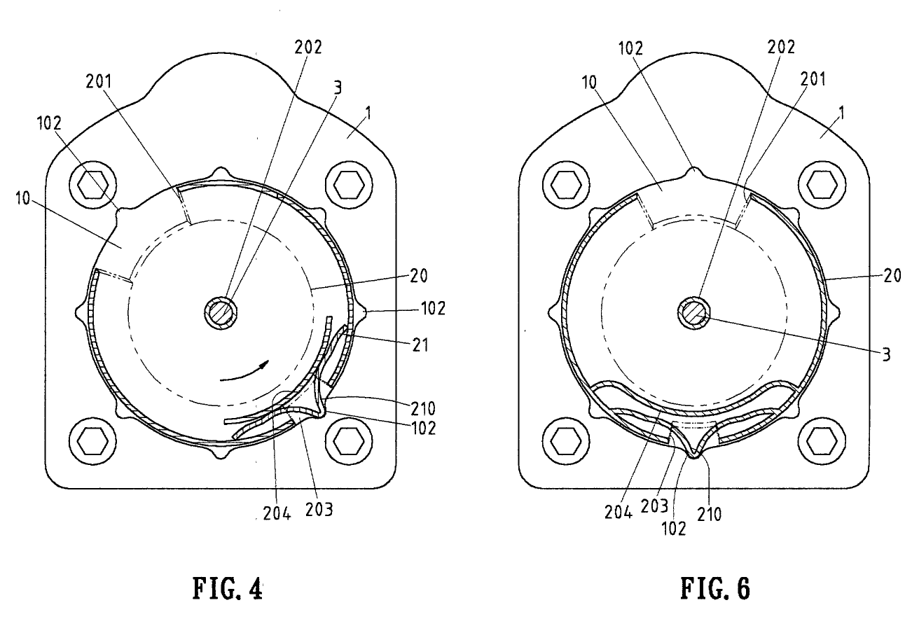

Referring to FIGS. 3 and 4, when the user wants to shift the position of the opening 201, he or she pushes the protrusion 210 inward to disengage from the notch 102 and then rotates the cap 2 till the protrusion 210 is engaged with another notch 102 again. By this way, the exhaust air releases from the opening 201 which is adjusted to a desired position.

Referring to FIG. 6, the biasing piece 21 can be made as a one-piece member with the cap 2 and includes a protrusion 210 that extends through the cur-away 203 and is engaged with one of the notches 102.

While we have shown and described the embodiment in accordance with the present invention, it should be clear to those skilled in the art that further embodiments may be made without departing from the scope of the present invention.

What is claimed is:

1. An exhaust air guiding assembly for a pneumatic tool, comprising:
a base with a recess defined therein and a plurality of positioning devices defined in an inner periphery of the recess, and
a cap rotatably engaged with the recess and a biasing piece connected to the cap, an opening defined through the cap and the biasing piece engaged with one of the positioning devices.

2. The assembly as claimed in claim 1, wherein the cap includes a top and a skirt through which the opening is defined, a backing plate extending from a back surface of the skirt and a cut-away defined in the skirt, the backing plate located in correspondence to the cut-away, the biasing piece contacting the backing plate and having a protrusion which extends through the cut-away and engaged with one of the positioning devices.

3. The assembly as claimed in claim 2, wherein the positioning devices are notches.

4. The assembly as claimed in claim 1 further comprising a tube extending from an underside of the top of the cap and a bolt extending through the tube and engaged with an inside of the recess.
